(19) United States
(12) Patent Application Publication
(10) Pub. No.: US 2015/0021352 A1
(43) Pub. Date: Jan. 22, 2015

(54) WIRELESS IC TAG INJECTION APPARATUS

(71) Applicant: MITOMO CORPORATION, Kanagawa (JP)

(72) Inventor: Kikuo KAGA, Tokyo (JP)

(73) Assignee: MITOMO CORPORATION, Kanagawa (JP)

(21) Appl. No.: 14/253,180

(22) Filed: Apr. 15, 2014

(30) Foreign Application Priority Data
Jul. 22, 2013 (JP) 2013-152105

(51) Int. Cl. G07F 11/44

(52) U.S. Cl. CPC G07F 11/44
USPC 221/174

(57) ABSTRACT

A wireless IC tag injection apparatus has a rotary tag-feeding mechanical section feeding IC tags to a delivering guide pass, while receiving wireless IC tags falling from a tag-housing hopper to outer circumferential pockets provided to a rotating disc, and a first tag-sorting mechanical section arranged at the lower end of the delivering guide pass and adapted to switch a delivering pass between two branched passes alternately. The apparatus also has a tag temporary-shutoff mechanical section and a data writing/reading device both provided to the branched pass, a second tag-sorting mechanical section arranged at the lower end of the branched pass and adapted to sort the data-processed IC tags to defective tag evacuation side and conforming tag feeding side, and a tag-injecting section connected to the conforming tag feeding section in the second tag-sorting mechanical section.

### FIELD OF INVENTION

The present invention is related to an apparatus for injecting wireless IC tags into material, which is adapted to inject wireless IC tags into liquid, viscous or semi-solid material under being kneaded and to perform writing and reading information to/from a wireless IC tag by means a radio communication system.

### BACKGROUND ART

Quality management of a concrete structure and examination of construction records and the like have been conducted by implementing wireless IC tags which are designed to be embedded into a concrete construction, to which various product information is inputted and from which such information is read by means of a radio communication system, for aiming at carrying out posterior survey with respect to earthquake-resistance strength of a concrete construction and verification of construction records and the like. It has been known as well to execute quality management of not only a concrete construction but also molded articles made of resin by putting wireless IC tags into the viscous material before being cured to thereby write information from the outside to a wireless IC tag and to read information stored in a wireless IC tag to send it to the outside.

As disclosed in Patent Document No. 1, as a device for injecting wireless IC tags into material, in each of those which a means for writing and reading information to/from a wireless IC tag is built into, is provided a device for putting wireless IC tags into material, in each casing of those which a radio reader/writer for the wireless IC tag, an IC tag feeding device, various sensors and control units, etc. are assembled, said casing is loaded on the lid of a mixing/kneading tank for fresh container, and which is configured such that wireless IC tags are put into said kneading tank through an inlet formed on said lid. Whereas, the device for processing data of a wireless IC tag and putting wireless IC tags into a mixing and kneading tank disclosed in Patent document No. 2, said device is configured such that wireless IC tags falling on a chute from housing hopper via horizontal circular feeding pass are divided in turn into three passages and the wireless IC tags are released one by one from each passage in the lateral direction by means of compressed air so as to be fed into the mixing/kneading tank laid below via an air hose.

On the other hand, an upright-type wireless IC tag injection apparatus, wherein a plurality of pressure feeding sections are arranged on the apparatus in both upward and downward directions, and it is configured that wireless IC tags falling downward in the vertical direction from a housing hopper and a drop chute are pushed in series to the pressure feeding sections so that the wireless IC tags are released with compressed air in the lateral direction to thereby reduce the bearing area of the apparatus itself in order to make possible to set the apparatus on a position being remote from the mixing/kneading tank, and the amount of time required for releasing one wireless IC tag can be shortened, has been developed as well (See Patent Document No. 3).

### REFERENCE OF THE PRIOR ART

### Patent Documents

[Patent Document 1]: Japanese Unexamined Patent Application Publication No. 2011-28541

[Patent Document 2]: Japanese Unexamined Patent Application Publication No. 2011-258030

[Patent Document 3]: Japanese Unexamined Patent Application Publication No. 2012-155404

### SUMMARY OF THE INVENTION

For the wireless IC tag injection apparatus of the above-described type, it is required to configure the apparatus in a lightweight and compact structure that enables to set the apparatus without trouble even under narrow place in the workplace, and furthermore, function of safely and continuously feeding tags is required in view of the operation efficiency. Moreover, the apparatus must be structured such that it can prevent operational defects of the respective mechanical components, in particular the blocked-up of the tags in the tag feeder and the tag-feeding passages from occurring in order to inject tags during kneading and stirring of the material that receives the tags. Still further, the apparatus is required to be capable of injecting accurate number of tags at any time during the injecting operation and to have a structure with excellent operability with which the checkout and repair of the respective component of the apparatus can be promptly made.

Therefore, it is an object of the present invention to provide a wireless IC tag injection apparatus by which the above-mentioned various requirements can be satisfied.

More specifically, it is an object of the present invention to provide a wireless IC tag injection apparatus which performs stable tag-feeding function and having high dust resistance property.

Furthermore, it is a still further object of the present invention to provide a wireless IC tag injection apparatus which employs an electrically-driven means to realize a driving source for the tag-feeding mechanical section and the tag-injecting mechanical section in the apparatus and which employs air-injection system only for the injection of wireless IC tags from the main body side of the apparatus to the tag-injecting unit, in order to realize weight saving and compactification of the apparatus as a whole so that stability in the tag-feeding and the operability at the construction site can be secured.

The above-described and the other objects and effects of the present invention will be further explained specifically in the embodiments described below with referring to the appended drawings.

The above-described object of the present invention is achieved by the wireless IC tag injection apparatus characterized by comprising;

rotary tag-feeding mechanical section for delivering IC tags to a delivering guide pass while receiving IC tags to the circumferential pocket of a rotating disc,

tag temporary-shutoff mechanical section and a data writing/reading device, both of those which are arranged below the delivering guide pass, and

tag-injecting section.

The wireless IC tag injection apparatus according to a further embodiment of the present invention is characterized by comprising;

rotary tag-feeding mechanical section for delivering IC tags to a delivering guide pass while receiving IC tags to the circumferential pocket of a rotating disc,

first tag-sorting mechanical section arranged at the lower end of the delivering guide pass and being adapted for switching a pass for guiding tags from the delivering guide pass to a branched pass,

tag temporary-shutoff mechanical section and a data writing/reading device, both of those which are arranged at the branched pass, and

tag-injecting section.

The wireless IC tag injection apparatus according to still further embodiment of the present invention is characterized by comprising;

rotary tag-feeding mechanical section for delivering IC tags to a delivering guide pass while receiving IC tags to the circumferential pocket of a rotating disc,

first tag-sorting mechanical section arranged at the lower end of the delivering guide pass and being adapted for switching a pass for guiding tags from the delivering guide pass to a branched pass,

tag temporary-shutoff mechanical section and a data writing/reading device, both of those which are provided to the branched pass,

second tag-sorting mechanical section arranged below the branched pass and being adapted to sorting the IC tags which have been subjected to the data processing to either defective tag evacuating side or conforming tag delivering side, and

tag-injecting section coupled to the conforming tag feeding section in the second tag-sorting mechanical section.

According to still further embodiment of the present invention, the wireless IC tag injection apparatus is characterized in that the rotating disc in the rotary tag-feeding mechanical section is supported with a shaft in the casing such that the outer circumference of the rotating disc either contacts or being close to the inner circumference of the casing, said rotating disc and said casing are arranged such that they are inclined obliquely-upward with respect to the holding frame, and a bottom plate for covering the lower part of the rotating disc is provided to the inside of the casing.

According to still further embodiment of the present invention, the wireless IC tag injection apparatus is characterized in that a dust evacuation outlet is formed in the lower part of the casing.

According to still further embodiment of the present invention, the wireless IC tag injection apparatus is characterized in that a tag-housing hopper is provided over the rotary tag-feeding mechanical section, said tag-housing hopper delivers tags to the delivering guide pass while receiving the tags falling from the tag-housing hopper to the outer circumferential pockets of the rotating disc.

According to still further embodiment of the present invention, the wireless IC tag injection apparatus is characterized by comprising an evacuated-tag quantity adjustment mechanical section provided to the falling chute being coupled to the tag-housing hopper and an evacuated quantity detection mechanical section provided to the lower part of the rotary tag-feeding mechanical section and the tag quantity to be evacuated through the tag evacuated-tag quantity adjustment mechanical section is adjusted by detection signals generated from the evacuated quantity detection mechanical section.

According to still further embodiment of the present invention, the wireless IC tag injection apparatus is characterized in that the evacuated-tag quantity adjustment mechanical section comprises a rotary tongue-like plate and a rotary driving device which rotates said rotary tongue-like plate, or a variable tongue-like plate coupled to the falling chute and an angle adjustment device which adjusts the inclined angle of the variable tongue-like plate, and that the evacuated-quantity detection mechanical section comprises a load cell which detects the weight of the tag-feeding mechanical section holding the wireless IC tags.

According to still further embodiment of the present invention, the wireless IC tag injection apparatus is characterized by comprising a sensor which detects IC tags in the delivering guide pass to rotate the rotary disc in the rotary tag-feeding mechanical section in response to a detection signal generated from the sensor when the quantity of the IC tags in the delivering guide pass comes to a value less than a preset value.

According to still further embodiment of the present invention, the wireless IC tag injection apparatus is characterized in that the delivering guide pass is constituted with several flexible long members being bundled but holding gaps between one and another, and that the inner space defined by the long members is used as a delivering pass for the IC tags.

According to still further embodiment of the present invention, the wireless IC tag injection apparatus is characterized in that the first tag-sorting mechanical section switches a delivering pass to two branched passes alternately.

According to still further embodiment of the present invention, the wireless IC tag injection apparatus is characterized in that the first tag-sorting mechanical section is arranged to the upper end of the branched pass and comprises a rotating disc provided with both a circumferential wall that closes the delivering pass and a tag-falling aperture formed by said circumferential wall in the outer circumference of said rotating disc and a sorting plate adapted to reciprocate so as to alternatively open or close said two branched passes, and that the rotating disc and the sorting plate interlock to take forward reverse rotation so that IC tags can be fed to the respective branched passes one by one in an alternate manner.

According to still further embodiment of the present invention, the apparatus is characterized in that an air-feeding pipe is connected to the casing of the apparatus which surrounds the rotary tag-feeding mechanical section, the first tag-sorting mechanical section, the tag temporary-shutoff mechanical section and the second tag-sorting mechanical section so that the inside of the apparatus casing is kept in pressure-applied condition.

According to still further embodiment of the present invention, the apparatus is characterized in that it comprises an injection outlet unit to be connected to the tag-injecting section at the apparatus main body side, and that the injection outlet unit has a tag box being separated from the one at the apparatus main body side and the tag box is provided with a tag-introducing inlet to be coupled to the tag-injecting section and a tag-falling outlet for dropping tags into the objective material.

According to still further embodiment of the present invention, the apparatus is characterized in that a shock-absorbing material is stuck to the tag-introducing inlet and the inner wall being opposite to the tag-introducing inlet of the tag box, respectively.

According to still further embodiment of the present invention, the apparatus is characterized in that an air-bleeding hole is formed in the upper plate of the tag box.

According to still further embodiment of the present invention, the apparatus is characterized in that a tag-eliminating tray adapted to be drawn is provided to the tag-falling outlet of the tag box, and the tag-eliminating tray is adapted to be folded under the state having been drawn from the tag-falling outlet such that the tray faces to the lateral side of the tag box.

According to still further embodiment of the present invention, the apparatus is characterized in that the injection inlet unit is connected to the apparatus main body either directly or via a delivering duct.

The wireless IC tag injection apparatus according to the present invention is configured so that stable tag-feeding can be realized thanks to the tag-feeding mechanism using a rotary disc having a tag-holding pocket on its outer circumference and that writing and reading information to/from a tag and injecting tags can be efficiently performed.

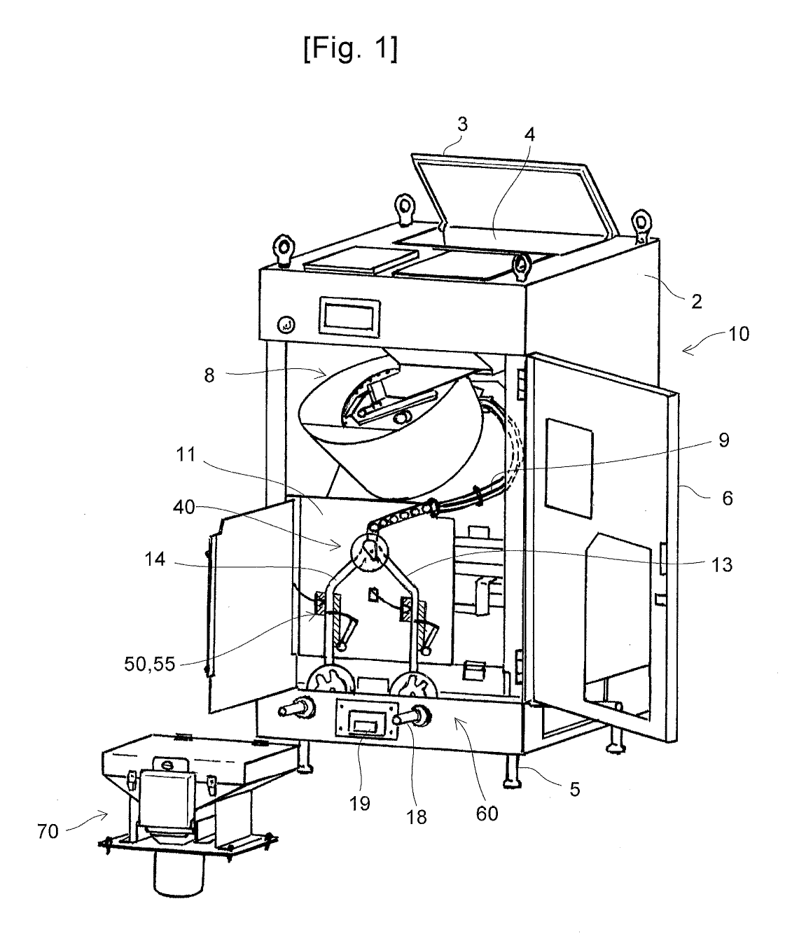

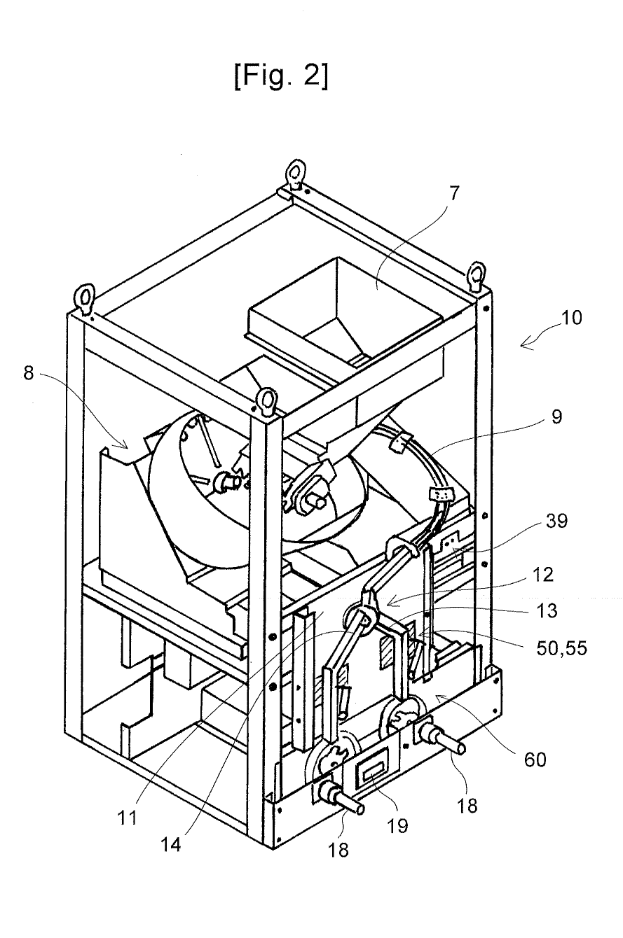

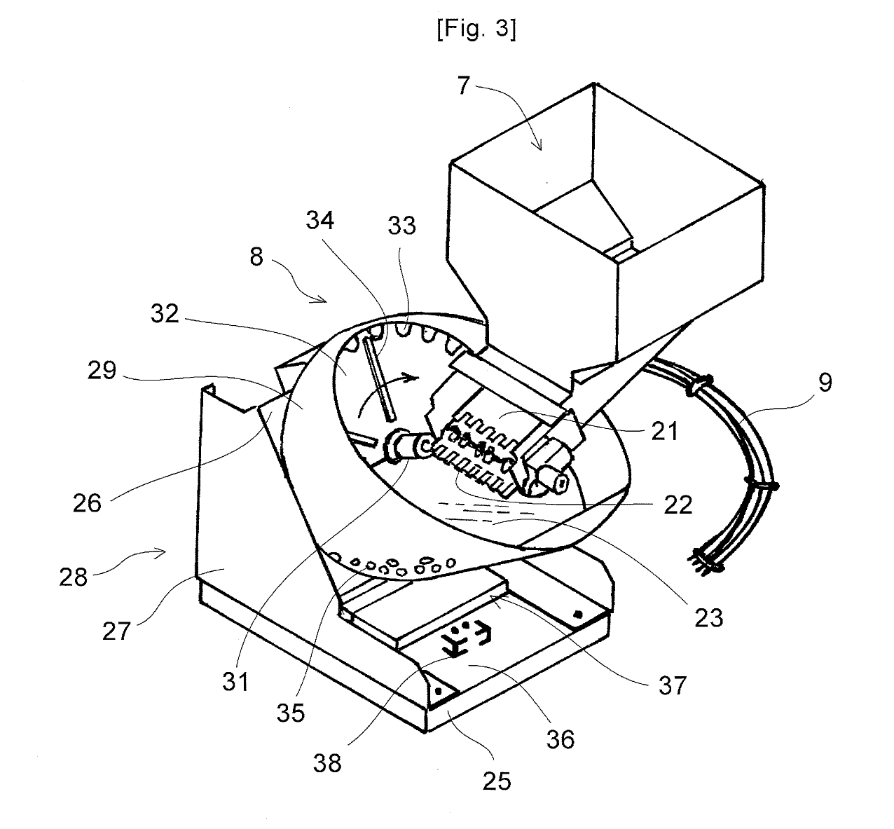

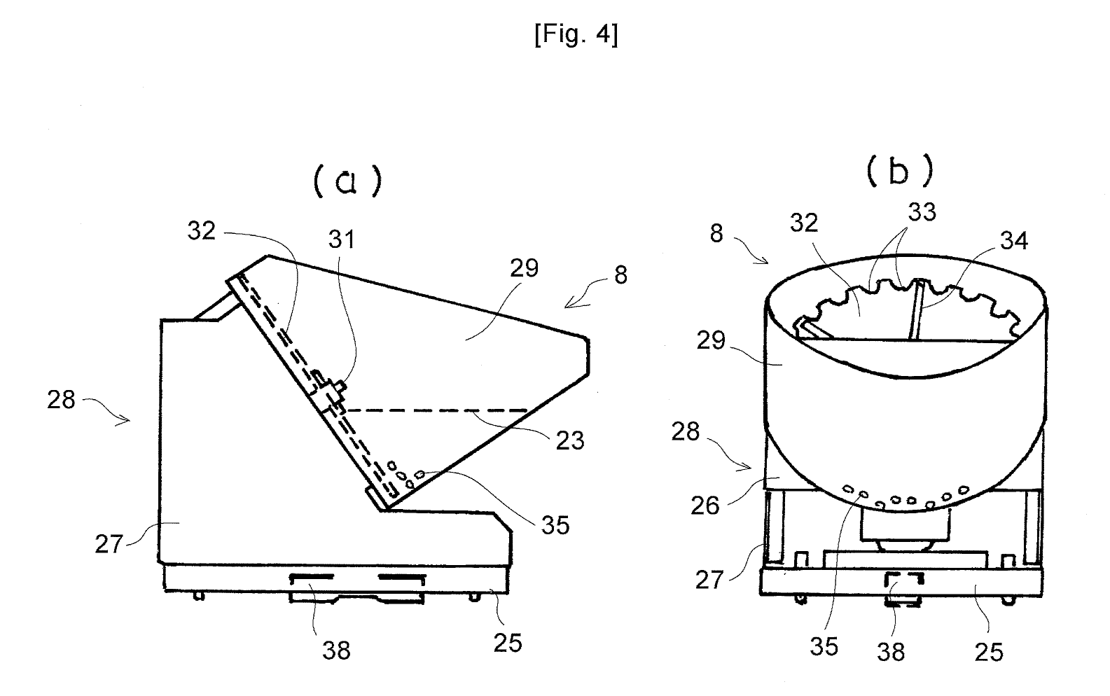

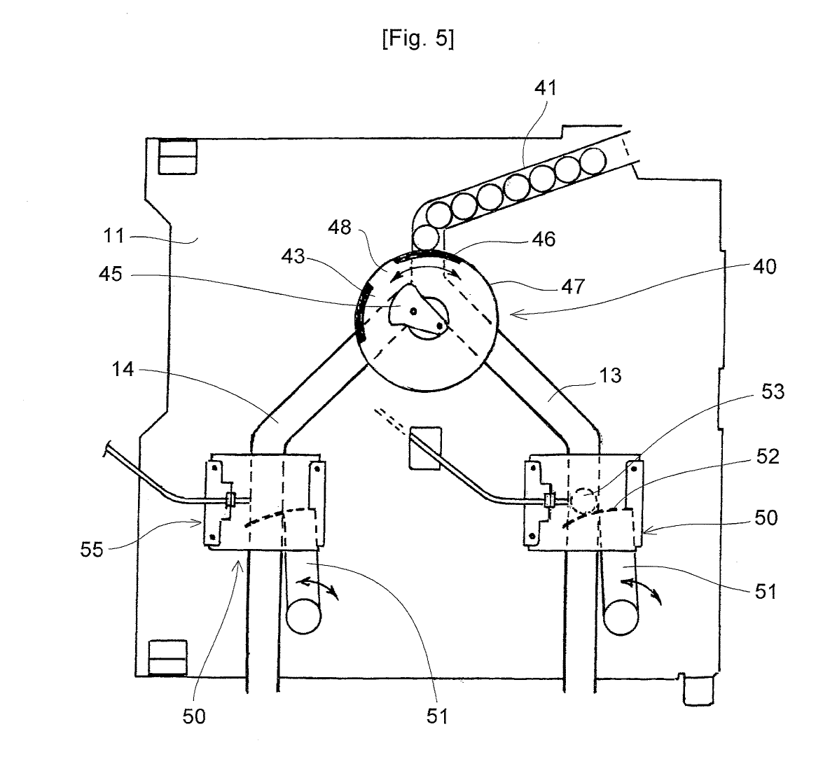

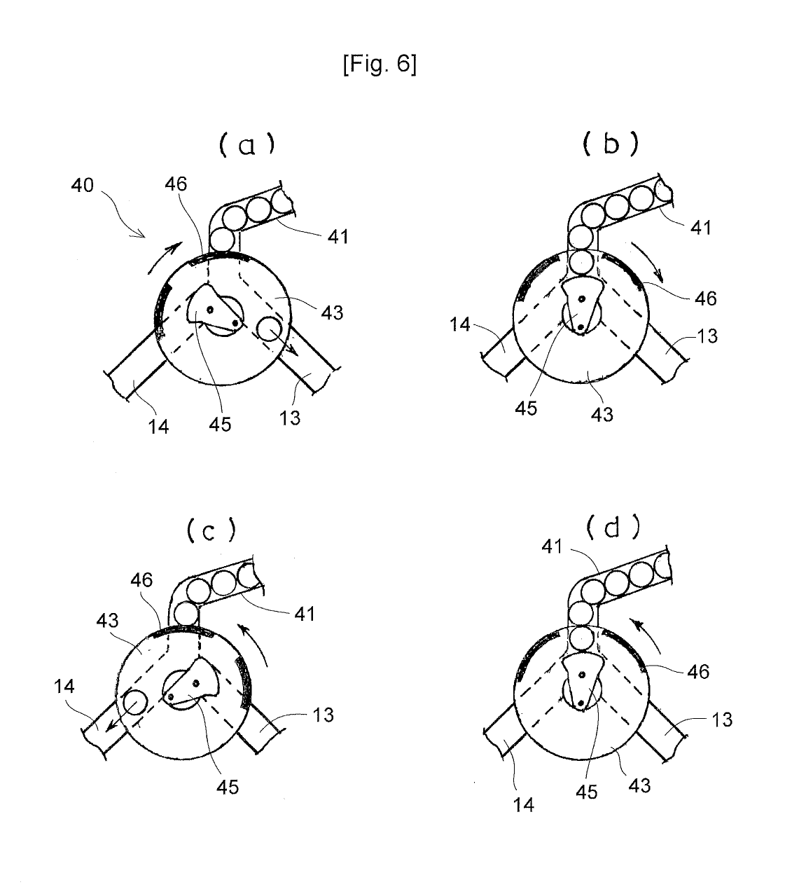

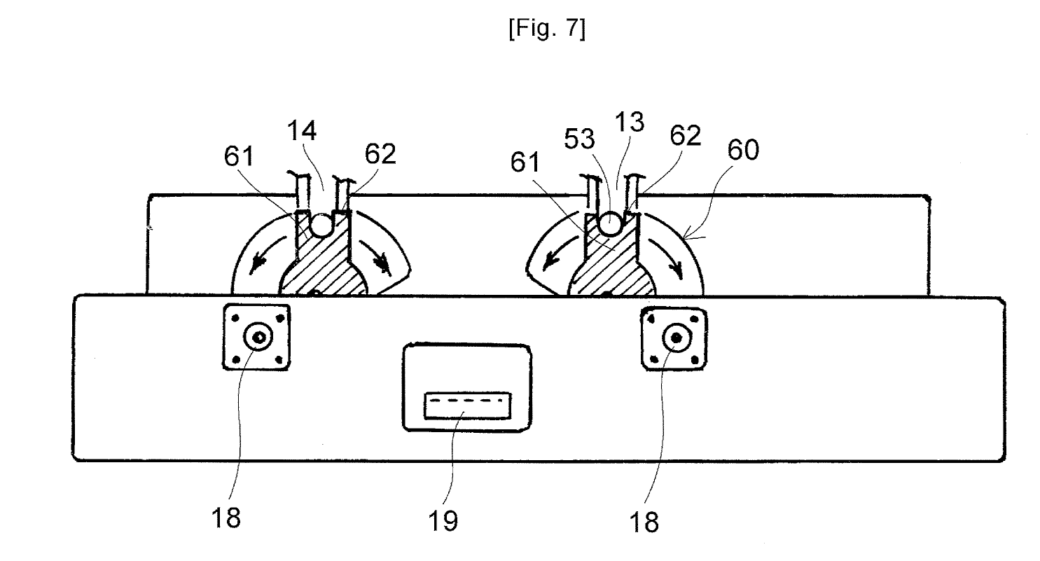

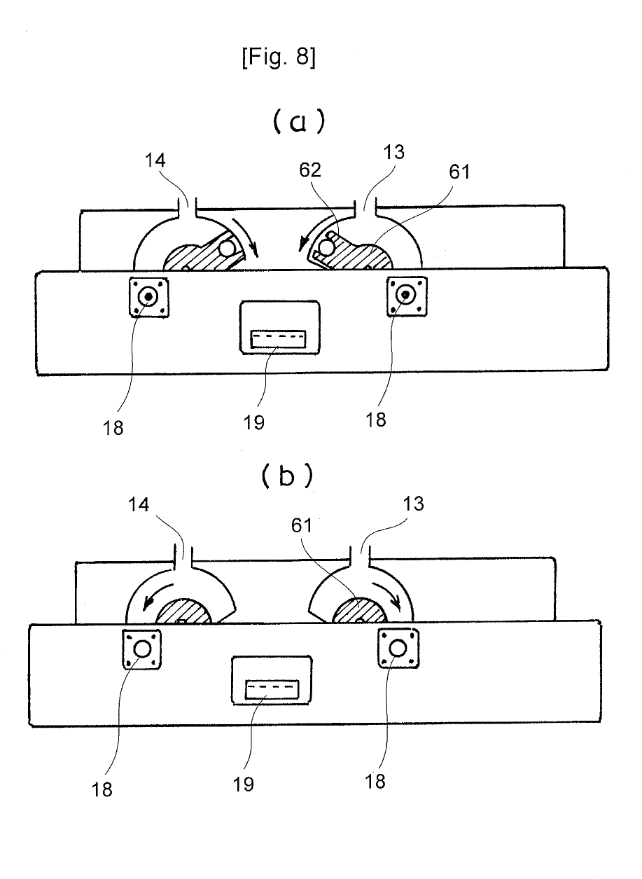

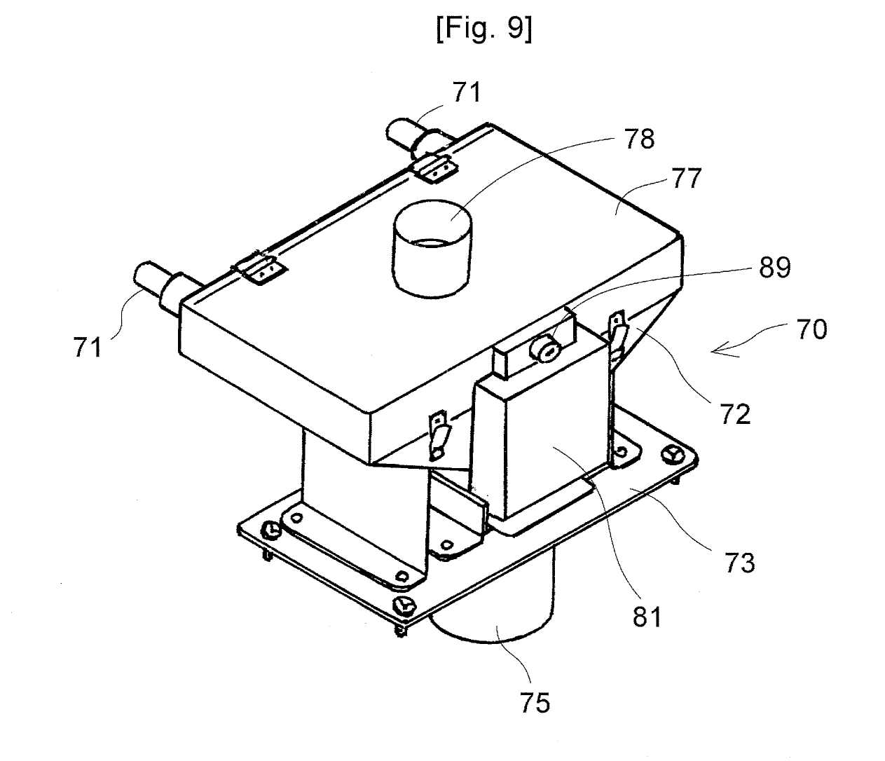

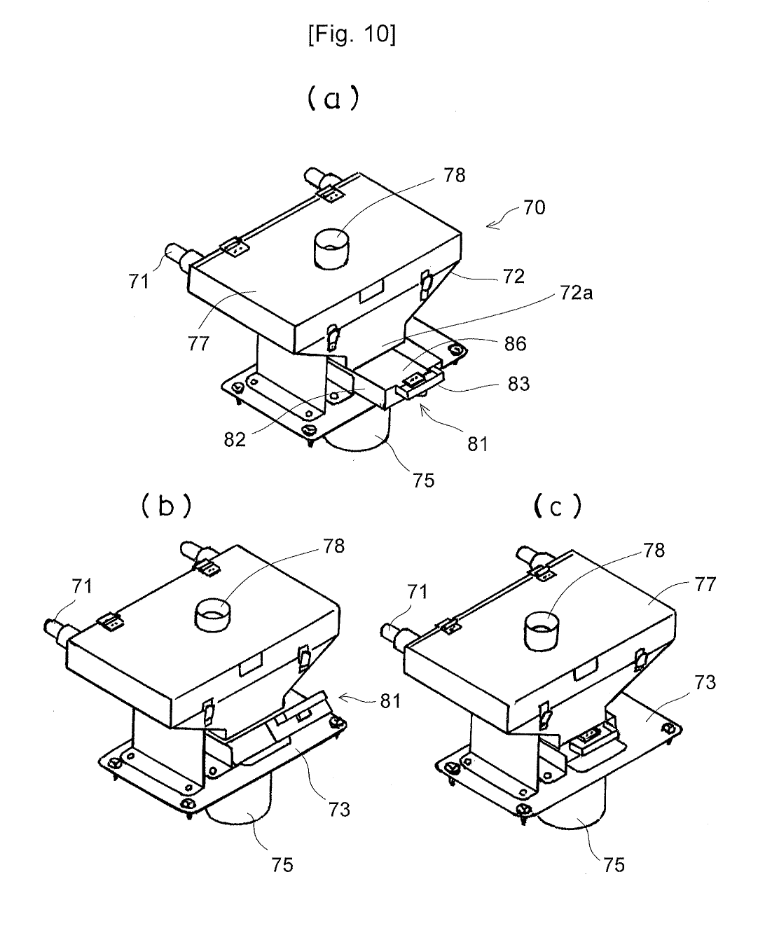

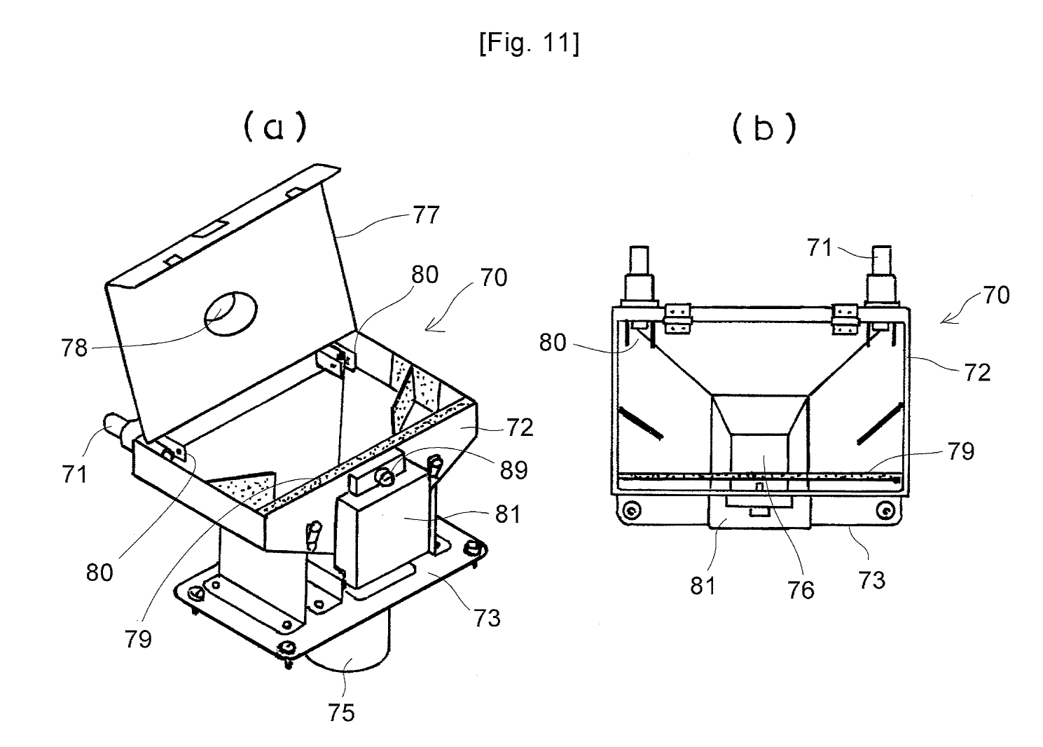

### BRIEF DESCRIPTION OF THE DRAWINGS

[FIG. 1] A total appearance drawing of the wireless IC tag injection apparatus according to the present invention, wherein the front door of the apparatus is opened.

[FIG. 2] A perspective view illustrating the total appearance of the interior of the casing of the wireless IC tag injection apparatus shown in FIG. 1.

[FIG. 3] A perspective view illustrating the tag-housing hopper and the rotary tag-feeding mechanical section of the wireless IC tag injection apparatus according to the present invention.

[FIG. 4] Front (b) and side (a) views of the rotary tag-feeding mechanical section shown in FIG. 3.

[FIG. 5] A front view of the first tag-sorting mechanical section and the tag temporary-shutoff mechanical section according to one embodiment of the present invention.

[FIG. 6] A front view illustrating how to operate IC tag sorting in the first tag-sorting mechanical section shown in FIG. 5.

[FIG. 7] A front view of the second tag-sorting mechanical section according to one embodiment of the present invention.

[FIG. 8] A front view illustrating the operations at the time of delivering conforming tags (a) and at the time of evacuating defective tags (b) in the second tag-sorting mechanical section shown in FIG. 7.

[FIG. 9] A view looked at an oblique direction illustrating the state when tags are injected through the injection outlet unit according to one embodiment of the present invention.

[FIG. 10] A view looked at an oblique direction illustrating the operations to pull out and put in the tag-eliminating tray provided to the injection outlet unit.

[FIG. 11] A view looked at an oblique direction (a) and a top view (b) both illustrating the state of the injection outlet unit shown in FIG. 9, wherein the lid of the unit having been opened.

### DETAILED DESCRIPTION OF THE PREFERRED EMBODIMENTS

Now, a preferred embodiment of the present invention will be explained with referring to the appended drawings. Although an example in which IC tags are injected into fresh concrete is exemplified in the embodiment described below, the objective to which IC tags are injected is not limited to fresh concrete, and liquid, viscous material-like and semi-solid materials, such as thermoplastic and thermosoftening resin materials and pre-cured gypsum materials can be applied as such objective. Further, as an example for the wireless IC tag to be injected, a cylindrical tag, the upper and lower surfaces of which are substantially circular-shaped and the main body of which is covered with a protective member, a drum-shaped tag, the middle of the circumferential part thereof is made higher in the height than the other part, a spherical tag, an elliptic tag or a tag being shaped so as to rotate on a inclined surface can be given.

As shown in the view looked at an oblique direction of FIG. 1, the main body 10 of the wireless IC tag injection apparatus according to this embodiment is housed in the casing 2, which is shaped in a rectangular solid having a bottom, a personal computer housing section 4 having an openable and closable lid 3 is provided on the upper surface of the casing 2, and legs 5 for maintaining the bottom of the casing at a given height relative to the floor surface are fixed to the bottom of the casing. Note that the leg 5 may be provided with a caster capable of transferring the apparatus. An openable and closable door 6 is provided to the front side of the casing so that the tag passage and main components, such as various electrically-powered components, air-controlling components and the driving components can be checked up. An air hose (not shown) coupled to the exterior air-feeding pump is connected to either back or lateral side of the casing 2 or the other appropriate part so that the interior of the casing 2 can be kept in pressure-applied state under the condition of closing the openable and closable door 6 and the invasion of dust from the outside into the casing 2 during the operation can be prevented from occurring.

Referring to FIG. 2, a tag-housing hopper 7 for receiving the wireless IC tags is provided over the casing, and next to said tag-housing hopper 7, a rotary tag-feeding mechanical section 8 for delivering the wireless IC tags to delivering guide pass 9 is provided beneath the tag-housing hopper. The lower end of the delivering guide pass 9 is connected to the first tag-sorting mechanical section 40 arranged in the front plate 11, where the delivering pass for delivering IC tags is branched to two passes 13, 14, and the wireless IC tags delivered from the delivering guide pass 9 are sorted one by one to these passes 13, 14 alternately. The branched passes 13, 14 each extend perpendicularly downward on the way, whereto the tag temporary-shutoff mechanical section 50 and the data writing/reading device 55 are arranged. Further, wireless IC tags data-processed in the data writing/reading device 55 are sorted in the second sorting mechanical section 60 to the conforming tag feeding side and the defective tag evacuating side, and the conforming tags are injected by means of pressured-air toward the tag-injecting outlet 18 and the defective tags are transferred to the NG tag collection box 19.

The wireless IC tag injection apparatus is provided with the injection outlet unit 70 as described later. The injection outlet unit 70 is configured in the form of tag box provided with a tag-falling duct extending downward toward the mixing and kneading tank and a tag-introducing inlet connected the tag-injecting outlet at the apparatus main body side either directly or via a pipe or the like such that it is separated from the main body section 10 and adapted to be detachably attached to a housing tank for the material to which the wireless IC tags are injected, e.g. a mixing and kneading tank for fresh concrete. The injection outlet unit will be further described later with referring to FIGS. 9 through 11.

Although the constitution in outline of the wireless IC tag injection apparatus according to said embodiments is explained above, the other electrically-powered components, control equipments, measurement and detection equipments, etc. are obviously built in the apparatus. Further, in the system supplying wireless IC tags to the rotary tag-feeding mechanical section 8, the tags are supplied not only from the hopper 7 but also by various means, e.g. via delivering pass from the other place. Note that the first tag-sorting mechanical section 40 may be equipped arbitrarily, and the branched passes of the tag-sorting mechanical section 40 is not limited to two lines, and required number of line can be provided. The second tag-sorting mechanical section 60 and the injection outlet unit 70 may be provided arbitrarily.

Next, the details of the above-described components will be explained with referring to FIG. 3 afterwards. As can be seen from FIG. 3, a rotary tongue-like plate 22 working as a evacuated-tag quantity adjustment mechanical section is supported with a shaft at the lower end of the chute 21 of the tag-housing hopper 7. By actuating the rotary driving device to rotate the rotary tongue-like plate 22 with respect to the surface of the chute, a given quantity of wireless IC tags can be supplied from the chute 21 to the rotary tag-feeding mechanical section 8, and the wireless IC tags supplied from the tag-housing hopper 7 via the chute 21 and the rotary tongue-like plate 22 are accumulated onto the bottom plate 23 in the rotary tag-feeding mechanical section 8.

Alternatively, the evacuated-tag quantity adjustment mechanical section may be configured such that a variable tongue-like plate, the inclination angle of which can be varied with respect to the chute surface is supported with a shaft at the lower end of the chute 21 of the tag-housing hopper 7, so that the quantity of the evacuated wireless IC tags from the chute 21 may be adjusted by changing the angle of the variable tongue-like pate with respect to the chute surface by means of the angle adjustment device. The wireless IC tags supplied from the tag-housing hopper 7 via the chute 21 and the variable tongue-like plate are accumulated onto the bottom plate 23 in the rotary tag-feeding mechanical section 8.

The rotary tag-feeding mechanical section 8 is mounted on the base 25 installed in the apparatus casing. As shown in FIGS. 3, 4(a) and 4(b), a holding frame 28 comprising an inclined pedestal 26 being opposite to the front side, side plates 27 clamping to hold both lateral sides of the inclined pedestal 26 and the bottom plate 23 is mounted on the base 25. In this embodiment, the inclined pedestal 26 of the holding frame 28 is inclined backward at an angle of about 45 degree. To this inclined pedestal 26, an end (the bottom edge) of a tubular body 29 is fixed. Note that the central axial line of the tubular body 29 is perpendicular with respect to the surface of the inclined pedestal 26. The other end (the upper edge) of the tubular body 29 is cut at a given angle with respect to the axial line of the tubular body 29 such that the cut surface faces upward. A rotatable shaft 31 extending perpendicularly with respect to the inclined pedestal into the tubular body 26 is supported on the inclined pedestal 26 with a shaft, and the rotating disc 32 described later is fixed to the rotatable shaft 31.

Plural tag-housing pockets 33 are formed as outer circumferential pockets with a given distance kept therebetween to the outer circumference of the rotating disc 32, and the outer circumference is adapted to contact with the inner circumference of the tubular body 29 to rotate thank to the rotating drive of the rotatable shaft 31. Further, the bottom plate 23 being substantially horizontal, which covers substantially the lower half of the rotating disc 32 is fixed in the tubular body 29 such that it contacts with or be close to the inner surface of the tubular body 29.

One end of the delivering guide pass 9 is positioned in proximity to the outer circumference of the tubular body 29 and the lower end of the delivering guide pass 9 being in the curved state extends downward. The wireless IC tags delivered and accumulated on the bottom plate 23 in the tubular body 29 in the rotary tag-feeding mechanical section 8 from the hopper 7 via the chute 21 are taken into the outer circumferential pockets 33 of the rotating disc 32 in turn thanks to the rotating drive of the rotating disc 32, while the wireless IC tags fallen from the pockets 33 are delivered to the delivering guide pass 9 thanks to the rotating movement of the tubular body 29. Note that the bottom plate 23 may be arranged in a slightly-inclined state so that the side thereof being close to the rotating disc 32 is positioned at a low level. Further, a striate convex 34 extending radially from the center is formed on the surface of the rotating disc 32 so that the wireless IC tags having been accumulated from the bottom plate 23 to the level in proximity to the rotating disc 32 are easily received in the outer circumferential pockets 33 of the rotating disc 32. A plurality of small dust accumulation-preventing apertures 35 is formed in the lower circumference at the front side of the tubular body 29 so that dust invaded into the tubular body 29 during construction is eliminated to the dust tray 37 set on the bottom plate 36 of the holding frame 28 through the aperture 35.

A load cell 38 is arranged between the base 25 and the bottom plate 36 of the holding frame 28. This load cell 38 is configured to detect the weight of the tubular body 29 holding the wireless IC tags via the holding frame 28 to thereby detect the residual quantity of tags held in the tubular body simply and with high accuracy. In this embodiment, the quantity of the remained wireless IC tag can be detected, for example, at an accuracy of Tag Residual Quantity±10 pieces (Weight±50 g) more or less, however, said accuracy is not limited to this extent. Upon generation of detection signal for tag residual quantity, the rotary tongue-like plate 22 locating at the lower end of the chute rotates to thereby supply the wireless IC tags from the tag-housing hopper 7 into the tubular body until filled-up of the tubular body with the wireless IC tags is detected. However, if the filled-up with the wireless IC tags is not detected by the load cell 38 at that stage, it is detected as supply error, such as no wireless IC tags in the tag-housing hopper 7, and an error-detected signal will be generated. When the IC tag supply system using the variable tongue-like plate is employed, the inclined angle of the variable tongue-like plate at the lower end of the chute is changed because of the tag-detected signal for informing the quantity of the remaining tags so that the supply quantity of wireless IC tags to be supplied from the tag-housing hopper 7 is adjusted.

The delivering guide pass 9 is constituted in this embodiment by bundling four flexible wires such that a given gap can be kept between one wire and the other and that the central area surrounded by four wires is formed as cavity. Said cavity surrounded by four wires is used as a delivering passage for the wireless IC tags. By constituting the delivering guide pass 9 as described above, accumulation of dust in the delivering pass can be prevented from occurring.

A tag sensor 39 for detecting tags is provided in the area in vicinity and close to the delivering guide pass 9. When there is no wireless IC tags in this area in the delivering guide pass 9, the rotating disc 32 is actuated to thereby feed the wireless IC tags into the delivering guide pass 9. The rotation of the rotating disc 32 is stopped when the delivering guide pass 9 is filled up with the wireless IC tags so that the feeding of wireless IC tags is discontinued.

The wireless IC tags sent through the delivering guide pass 9 is then sorted one by one to two branched passes 13, 14, alternately in the first tag-sorting mechanical section 40. As shown in FIG. 5, the tag-introducing pass 41 connected to the lower end of the delivering guide pass 9 is formed in the upper position of the front plate 11, said lower end slightly extends downward in the perpendicular direction and is connected to two inclined branched-passes 13, 14. A swinging rotary plate 43 is supported at the connecting portion of the tag-introducing pass 41 and the branched passes 13, 14 with a shaft, and a fan-shaped sorting plate 45 is fixed to the center of the rotating plate 43. A circumferential wall section 46 is formed in the outer circumference of the swinging rotary plate 43, and at least two IC tag passing apertures 47, 48 are formed in the circumferential wall section 46 so as to be away therefrom in the circumferential direction. The swinging rotary plate 43 and the sorting plate 45 jointly repeat rotations in a prescribed range alternately in both right and left directions, said two branched passes 13, 14 are opened alternately in response to said rotations so that wireless IC tags are fallen one by one under its weight into the opened branched-pass 13 or 14. This movement will be explained in the following with referring to FIGS. 6(a) through 6(d).

As shown in FIG. 6(a), in the state that both rotating disc 43 and sorting plate 45 have turned to the left side, the branched pass 13 at the right side is opened and wireless IC tags fall into the branched pass 13 at the right side, while the following wireless IC tags are intercepted by the outer circumferential wall 46 of the rotating plate 43 and are not fed into the branched pass. Immediately thereafter, the rotating disc 43 and the sorting plate 45 rotate clockwise, wireless IC tags being intercepted by the circumferential wall 46 come over the sorting plate 45 (FIG. 6(b)) when the passing aperture in the outer circumference of the circumferential wall 46 of the rotating disc 43 and the delivering guide pass 41 are fitted, and the subsequently-coming wireless IC tags are intercepted by the outer circumferential wall 46 of the rotating disc 43 to stop the tags there due to continuous rotation of the rotating disc 43 in the same direction, the wireless IC tags on the sorting plate 45 then fall into the branched pass 24 at the left side when the other (at the left side) branched pass 14 is opened. FIG. 6(c) shows a state of such sorting operation described hereinabove.

Subsequently, in response to the reverse rotation (to the left side) of the rotating disc 43, the delivering guide pass 41 is opened thanks to the passing aperture of the circumferential wall 46, the wireless IC tags being stayed on the delivering guide pass 41 are placed on the sorting plate 45 (FIG. 6(d)), and the wireless IC tags on the sorting plate 45 fall into the branched pass 14 at the right side thanks to the continuous rotation of the rotating disc 43 in the same direction as shown in FIG. 6(a). Because of the reciprocal rotations of the rotating disc 43 in the right and left directions, the wireless IC tags are fallen one by one into the branched passes at the right and left sides alternately.

Note that, instead of the first tag-sorting mechanical section 40, the apparatus may be configured in such a structure that an opening and closing device, such as a shutter, is provided in the entrance of the branched pass to thereby sort the wireless IC tags to the branched passes thanks to the opening and closure of the shutter, or that a passage over the arc of the rotating disc is provided so that the branched pass is opened when said passage and the branched pass are overlapped to cause the wireless IC tags to be sorted into the branched passes. As described above, the structure of the first tag-feeding mechanical section can be configured in various fashions.

The wireless IC tags having entered into the branched pass is then temporarily stopped by the tag temporary-shutoff mechanical section for writing data thereto. As shown in FIG. 5, the temporary-shutoff mechanical section 50 is so structured that an end of the arm 51 is pivotally attached to the front plate 11 and a closure plate 52 adapted to enter and leave the branched pass is fixed to the other end of the arm 51. By virtue of the rotation of the arm 51, writing of required data to the wireless IC tag being stopped by the closure plate 52 is undertaken by the data writing/reading device 55, such as a reader/writer, and by virtue of the writing end signal, the arm 51 rotates in the reverse direction to cause the closure plate 52 to evacuate from the branched passes 13, 14 so that wireless IC tags fall into the second sorting mechanic section on the rear stage. Obviously, the operation of the rotating disc 43 in the first sorting mechanical section 40 and the rotating operation of the arm 51 of the temporary-shutoff mechanical section 50 are performed by electrically-powered means in the interlocked manner.

The second sorting mechanical section 60 to be arranged to the lower end of each branched pass is shown in FIG. 7, FIG. 8(a) and FIG. 8(b). In this embodiment, a folk-shaped sorting arm 61 adapted to be supported with a shaft on the center line of each branched pass and beneath each branched pass is used. The tip of the arm 61 is formed in a bifurcated folk-like section 62, the wireless IC tags 53 held by the folk-like section 62 are discriminated as a conforming tag or a defective tag by a discriminating means. Then, the sorting arm 61 rotates to the conforming tag side or the defective tag side in accordance with the result of said discrimination to drop the conforming IC tags into the tag-injecting outlet 18 and the defective IC tags into the defective tag collection box 19 disposed in opposite to the tag-injection outlet. FIG. 8(a) shows the state where defective IC tags are turned toward the defective tag collection box, and FIG. 8(b) shows the state where causing conforming IC tags to fall into the tag-injecting outlet 18. This turning operation of the sorting arm 61 is also actuated by electrically-powered means.

According to the present invention, discrimination and sorting of conforming IC tag and defective IC tag can be achieved just before injecting the IC tags into the objective material. Therefore, even though in such a condition that fresh concrete applied into a mixing/kneading tank has been changed to the other fresh concrete with a different composition during the operation, the IC tag injection apparatus can be advantageously operated in continuing manner without shutoff. In this regard, with the conventional apparatus, right and wrong discrimination and disposal by sorting of IC tags based on the specification being changed after completion of data processing by a reader/writer is impossible, and IC tags discriminated as conforming tags by a reader/writer are all directed to the injection outlet side, which causes disadvantage of feeding defective tags to be disposed into the objective material. Conversely, with the apparatus according to the present invention, the operation is not required to be interrupted even though the specification, such as the composition and the combination ratio, of fresh concrete, to which IC tags are discharged, is required to be changed so that defective tags and tags deviated from the specification can be immediately evacuated to the disposal side and accuracy of the quality of the injected IC tags and the operational efficiency of the apparatus can be improved.

Now, the injection outlet unit connected to the tag-injecting outlet, which is structured separately from the injection apparatus main body will be explained below with referring to FIGS. 9 to 11. In this injection outlet unit 70, a tag box 72 provided with a pair of tag-introducing passes 71 is held by the installation base 73. This installation base 73 is mounted on the upper surface of a mixing/kneading tank for the objective material or a concrete mixer vehicle via an adequate cradle. A cylindrical injection duct 75 is provided to the installation base 73, and a feeding outlet 76 being rectangular when looking from the top is formed at the lower portion of the tag box 72 and is coupled with the injection duct 75 extending downward from the back side of the installation base 73.

An openable and closable lid 77 is connected with hinges to the upper side of the tag box 72, and an air-bleeding hole 78 is formed in the upper side of the lid 77. When dust is generated in the tag box 72 due to blowing wind pressure caused at the time of falling of the aggregate, etc. into a mixing/kneading mixer, there is fear that the dust invades to the main body side of the apparatus via the tag-introducing pass 71 of the tag box 72 and the connecting pipe of the tag-introducing pass. The air-bleeding hole 78 in the lid 77 of the tag box 72 has function to let such wind pressure out and to prevent reverse flow of the dust to the main body side of the apparatus from occurring.

As shown in FIGS. 11(a) and 11(b), a shock-absorbing material 79, such as urethane sheet, is attached to the inner walls of the tag box 72 at the tag-introducing pass 71 side and at the opposite side thereof in order to prevent the inner walls of the tag box 72 at the tag-introducing pass 71 side and at the opposite side thereof from being damaged due to the collision of wireless IC tags injected from the tag-injecting outlet 18 of the injection apparatus. If appropriate, equivalent shock-absorbing material may be used for the right and left side walls of the tag box 72 or the inner walls of the lid 77 as well.

An injection completion detection sensor 80 for wireless IC tags is provided to the tag-introducing pass 71 for the tag box 72. An injected-tag eliminating tray 81 for eliminating the remained IC tags in the tag box at the time of completion of tag injection is provided to the tag box 72. Now, the tag-eliminating tray 81 will be explained with referring to FIGS. 9, 10(a) through 10(c). This tag-eliminating tray 81 has rectangular lateral plates 82 on its four lateral sides, the upper side of which is opened and formed in a shape of rectangular solid, and a pull for drawing the tray 81 from the tag box 72 is provided on the front side of the tray. The tag-feeding outlet 76 at the lower end of the tag box 72 is formed in a square shape, the tray 81 is inserted and drawn relative to the tag box such that the right and left lateral plates 82 of the tray are guided to the inner sides of both lateral sides of the feeding outlet 76 at the lower end of the tag box and the bottom plate 86 of the tray 81 slides on the plate surface of the installation base 73 of the tag box 72.

Further, under such condition that the tray 81 has been drawn, the rear lateral plates in the back side (the side opposite to the front side) of the tray 81 are engaged with the inner surface of the front lateral portion of the square delivering outlet 76 locating at the lower end of the tag box so that further drawing of the tray 81 is restrained. The tray 81 can be held in the erect state by the tag box 72 (FIG. 9) by using the rear lateral plates of the tray 81 as a fulcrum to pivot the tray upward as shown in FIG. 10(b) such that tray 81 is contacted to the front side portion 72a of the tag box 72 under such condition that the tray 81 has been drawn frontward to the maximum extent. Under the condition described above, the wireless IC tags are injected into the mixing/kneading tank.

Note that a key means 89 which is adapted to fix the tray 81 under such condition that the tray 81 has been held to the front side of the tag box 72, is provided to the injection outlet. The insertion of the tray 81 to the tag box 72 is carried out not only at the time of eliminating the remained tags after completion of tag injection, but also at the time of injecting tags as a trial prior to the practical tag injection.

For the tag injection unit 70, although the tag-introducing pass 71 for the tag box 72 may be directly jointed to the tag-injecting outlet 18 in the injection apparatus main body, either a hose made of polyvinyl chloride or a delivering pipe such as a steel pipe is usually used for the connection between the tag injection outlet 18 in the injection apparatus main body and the tag-introducing pass 71 in the tag injection unit 70. With this structure, the main body side of the injection apparatus may be set to a place where no influence by dust to the tag-introducing components is occurred and a place where construction work will not be intervened, which improving the operability and the efficiency of working. Further, the delivering pipe is assembled with unit pipes each having a unit length and capable of being jointed to each other so that the total length of the delivering pipe can be adjusted by coupling the unit pipes with joints. Note that tag passing sensors may be provided to the tag-introducing pass in the injection inlet unit, the tag-injecting outlet in the injection apparatus main body and the hose joint section.

As explained above, many advantages as described below are provided by the wireless IC tag injection apparatus according to the present invention. (1) The region ranging from the tag-housing hopper to the tag-feeding mechanical section, the tag-sorting mechanical section, NG tag evacuation mechanical section just before injecting tags, etc. can be housed in the casing of the apparatus, which can provide the IC tag injection apparatus in total with a compact size and lightweight. (2) Since the apparatus feeds wireless IC tags one by one in turn thanks to the rotating movement of the rotating disc while receiving IC tags falling from the hopper into the outer circumferential pockets on the rotating disc arranged in an inclined state, stable tag-feeding to the tag-feeding mechanical section can be realized without causing occurrence of the remaining tags. (3) Thanks to the stable tag-feeding by the tag-feeding mechanical section, the flow from writing information to wireless IC tag to the tag injection pass can be completed through two lines in parallel, which makes the apparatus a high-efficiency IC tag injection apparatus. (4) Since the apparatus is so configured that all tag-feeding inside the apparatus can be accomplished in an electrically-powered rotary drive fashion and air-injection system is employed only for tag injection from the apparatus main body, the drive mechanism is simplified and the size of the apparatus can be further miniaturized. (5) Since a dust accumulation prevention means is provided to the tag-feeding mechanical section and the tag-delivering guide pass, respectively and the interior of the casing during the operation can be maintained in pressure-applied condition, blocking-up of tags due to dust and mechanic troubles will not be caused, and the IC tag injection apparatus with excellent dust resistance and reliability can be provided. (6) Since the load cell is provided to the bottom section of the tag-feeding mechanical section, detection of remained tags with high accuracy during the operation can be realized. (7) The apparatus is structured in consideration of the installation environment and the operability, and is configured so that all of the main mechanical sections can be operated at the front side of the apparatus casing. (8) Since the injection outlet unit is separated from the apparatus main body, the apparatus can be installed efficiently even in the narrow space and can enhance the operability of the apparatus in the construction site. Further, by setting the apparatus in a place being subjected to no dust influence and setting only the injection outlet unit to a concrete mixer vehicle or a mixing/kneading tank, dust resistance of the apparatus main body can be secured.

### DESCRIPTION OF THE REFERENCE NUMERALS

2: Casing
3: Openable and closable lid
4: Personal computer housing section
5: Leg
6: Opening and closing door
7: Tag-housing hopper
8: Rotary tag-feeding mechanical section
9: Delivering guide pass
10: Wireless IC tag injection apparatus main body
11: Front plate
13, 14: Branched pass
18: Tag-injecting outlet
19: Defective tag collection box
21: Chute
22: Rotary tongue-like plate
23: Bottom plate
25: Base
26: Inclined pedestal
28: Holding frame
29: Casing
31: Rotating shaft
32: Rotating disc
33: Tag-housing pocket
35: Dust accumulation prevention hole
38: Load cell
40: First tag-sorting mechanical section
41: Tag-introducing pass
43: Swinging rotary plate
45: Sorting plate
46: Circumferential wall
50: Tag temporary-shutoff mechanical section
51: Arm
52: Closure plate
55: Data writing/reading device
60: Second tag-sorting mechanical section
61: Sorting arm
62: Folk-like section
70: Injection outlet unit
71: Tag-introducing pass
72: Tag box
73: Installation base
75: Injection pipe
76: Delivering outlet
77: Lid
78: Air-bleeding hole
79: Shock-absorbing material
81: Injected-eliminating tray
82: Lateral plate
89: Key means for injection outlet unit

1. A wireless IC tag injection apparatus characterized by comprising:
rotary tag-feeding mechanical section for delivering IC tags into delivering guide pass while receiving IC tags into circumferential pockets of the rotating disc,
tag temporary-shutoff mechanical section and a data writing/reading device both arranged beneath the delivering guide pass, and
tag-injecting section.

2. A wireless IC tag injection apparatus according to claim 1 characterized by comprising:
rotary tag-feeding mechanical section for delivering IC tags into delivering guide pass while receiving IC tags into circumferential pockets of the rotating disc,
first tag-sorting mechanical section arranged at the lower end of the delivering guide pass and adapted to switch a delivering pass to branched passes,
tag temporary-shutoff mechanical section and a data writing/reading device both arranged on the branched pass, and
tag-injecting section.

3. A wireless IC tag injection apparatus according to claim 1, characterized by comprising:
rotary tag-feeding mechanical section for delivering IC tags into delivering guide pass while receiving IC tags into circumferential pockets of the rotating disc,
first tag-sorting mechanical section arranged at the lower end of the delivering guide pass and adapted to switch a delivering pass to branched passes,
tag temporary-shutoff mechanical section and a data writing/reading device both arranged on the branched pass,
second tag-sorting mechanical section arranged at the lower end of the branched pass and adapted to sort the data-processed IC tags to defective tag evacuation side and conforming tag feeding side, and
tag-injecting section connected to the conforming tag feeding section in the second tag-sorting mechanical section.

4. A wireless IC tag injection apparatus according to claim 1, characterized in that the rotating disc in the rotary tag-feeding mechanical section is supported with a shaft such that the outer circumference of the rotating disc contacts to or is in proximity to the inner circumference of the casing, the rotating disc and the casing are arranged in the state of being inclined obliquely-upward with respect to the holding frame, and a bottom plate covering the lower part of the rotating disc is provided in the casing.

5. A wireless IC tag injection apparatus according to claim 4, characterized in that a dust evacuation hole is formed in the lower part of the casing.

6. A wireless IC tag injection apparatus according to claim 1, characterized in that a tag-housing hopper is provided over the rotary tag-feeding mechanical section, and that the rotary tag-feeding mechanical section delivers IC tags to the delivering guide pass while receiving IC tags falling from the tag-housing hopper to the circumferential pockets of the rotating disc.

7. A wireless IC tag injection apparatus according to claim 1, characterized in that the apparatus comprises an evacuated-tag quantity adjustment mechanical section provided to the falling chute in connection to the tag-housing hopper and an evacuated quantity detection mechanical section provided at the lower part of the rotary tag-feeding mechanical section, and that the evacuated quantity of tags at the evacuated-tag quantity adjustment mechanical section is adjusted in response to the detection signal generated by the evacuated-tag quantity detection mechanical section.

8. A wireless IC tag injection apparatus according to claim 7, characterized in that the evacuated-tag quantity adjustment mechanical section comprises a rotary tongue-like plate jointed to the falling chute and a rotary drive device for rotating the rotary tongue-like plate, or a variable tongue-like plate jointed to the falling chute and an angle adjustment device for adjusting the inclined angle of the variable tongue-like plate, and that the evacuated-quantity detection mechanical section comprises a load cell for detecting the weight of the tag-feeding mechanical section holding the wireless IC tags.

9. A wireless IC tag injection apparatus according to claim 1, characterized in that the apparatus comprises a sensor for detecting IC tags in the delivering guide pass, and that the rotary drive of the rotating disc in the rotary tag-feeding mechanical section is actuated in response to the detection signal generated from the sensor when the quantity of IC tags in the delivering guide pass comes to be less than a preset quantity.

10. A wireless IC tag injection apparatus according to claim 1, characterized in that the delivering guide pass is constituted with a plurality of flexible long members having been bundled but keeping gaps therebetween and the interior space defined by said long members is used as the delivering pass for IC tags.

11. A wireless IC tag injection apparatus according to claim 2, characterized in that the delivering pass is switched by the first tag-sorting mechanical section to two branched passes alternately.

12. A wireless IC tag injection apparatus according to claim 11, characterized in that the first tag-sorting mechanical section comprises a rotating disc arranged at the upper end of the branched pass and provided at the outer circumference with a circumferential wall blocking the delivering pass and a tag-falling aperture formed in the circumferential wall and a sorting plate provided to the rotating plate and reciprocally turning for selectively opening and closing the two branched passes, and that the rotating disc and the sorting plate are interlocked to perform forward reverse rotation so that IC tags are inputted one by one into each branched pass alternately.

13. A wireless IC tag injection apparatus according to claim 1, characterized in that an air-feeding pipe is connected to the apparatus casing surrounding the rotary tag-feeding mechanical section, the first tag-sorting mechanical section, the tag temporary-shutoff mechanical section and the second sorting mechanical section, whereby the inside of the apparatus casing is maintained under pressure-applied condition.

14. A wireless IC tag injection apparatus according to claim 1, characterized in that the apparatus comprises an injection outlet unit adapted to be connected to the tag-injecting section at the apparatus main body side, the injection outlet unit comprises a tag box which is different from the one at the apparatus main body side, and said tag box is provided with a tag-introducing inlet to be connected to the tag-injecting section and a tag-falling outlet for dropping IC tags into the objective material.

15. A wireless IC tag injection apparatus according to claim 14, characterized in that a shock-absorbing material is stuck to the inner wall of the tag box being opposite to the tag-introducing inlet.

16. A wireless IC tag injection apparatus according to claim 14, characterized in that an air-bleeding aperture is formed in the upper plate of the tag box.

17. A wireless IC tag injection apparatus according to claim 14, characterized in that a tag-eliminating tray capable of being drawn is provided to the tag-falling outlet of the tag box, and that the tag-eliminating tray is folded so that the tray faces to the lateral side of the tag box in such a state that the tray has been drawn from the tag-falling outlet.

18. A wireless IC tag injection apparatus according to claim 14, characterized in that the injection outlet unit is connected to the apparatus main body either directly or via a delivering pipe.
